(19) United States
(12) Patent Application Publication
(10) Pub. No.: US 2026/0322155 A1
(43) Pub. Date: Oct. 15, 2026

(54) MOBILE CHARGING DEVICES WITH VOLTAGE DETECTION FEATURES

(71) Applicant: Dongar Technologies LLC, Hayward, CA (US)

(72) Inventors: Kevin Philip Yu Sayo, San Leandro, CA (US); Maksym Trybunskyi, Prague (CZ)

(73) Assignee: Dongar Technologies LLC, Hayward, CA (US)

(21) Appl. No.: 19/647,817

(22) Filed: Apr. 14, 2026

Related U.S. Application Data
(60) Provisional application No. 63/788,448, filed on Apr. 14, 2025.

(51) Int. Cl. H02J 7/96; B60R 1/20; B60R 16/023; B60R 16/033; H01R 13/66; H01R 24/20

(52) U.S. Cl. CPC H02J 7/96; B60R 1/20; B60R 16/0232; B60R 16/033; H01R 13/6683; H01R 24/20; H01R 2201/26; H02J 2207/20; H02J 2207/30

(57) ABSTRACT

The present technology relates to mobile charging devices, and related methods and systems, for charging portable electronic devices such as mobile (cellular) phones, smartphones, cameras, and computers including tablet computers, wherein the devices have a cranking detection feature that is adapted to switch between a “default” mode and a “sleep” mode when the vehicle is parked for an extended period of time, providing the advantage of extended battery life of the vehicle. The present technology is also directed to methods of reducing the energy consumption of a mobile charging device located within a vehicle and connected through a connector to the vehicle battery and vehicle engine, as well as to systems encompassing such devices and methods.

### CROSS-REFERENCE TO RELATED APPLICATION

This application claims the benefit of U.S. Provisional Patent Application No. 63/788,448, filed on Apr. 14, 2025, the entire contents of which are incorporated herein by reference.

### BACKGROUND

The present technology relates to mobile charging devices for charging portable electronic devices such as mobile (cellular) phones, smartphones, cameras, and tablet computers; as well as to related methods and systems.

Portable electronic devices are typically charged with mobile charging devices that are plugged into electrical outlets. These can include electrical outlets that are permanently affixed to electrical grids, such as those in buildings; as well as those that are located inside vehicles and connect to the electrical systems of the vehicles.

However, a problem can arise when a vehicle is stopped (that is, its engine is turned off) for an extended period of time, such as when the vehicle is parked and not being driven for any time from several hours to several weeks.

Many users tend to leave their mobile charging devices plugged into a vehicle when parked, to avoid the inconvenience of plugging and unplugging power cords. However, even when not in active use, the mobile charging device can continue to drain the car's battery. This can lead to many disadvantages over time, such as shortened battery life and alternator failure. Another disadvantage is the likelihood of potentially reducing a vehicle's state-of-charge so low that the vehicle cannot restart its engine or even power its own electronics to open a door.

On the other hand, many vehicles have a feature that disables power outlets intended for the driver's mobile device charging (USB ports or cigarette lighter ports) when the vehicle is shut off. Vehicle manufacturers do not intend ‘always-on’ power to be available to the driver. However, drivers sometimes want access to this “always-on” power to install devices like dashcams (dashboard cameras) for 24-hr surveillance. This typically results in a custom wiring solution, and in such situations, managing the state-of-charge of the battery is a very common problem.

An ongoing need exists for mobile charging devices, methods, and systems that can sense when a vehicle is not operating and adjust to operate with a reduced energy consumption during those times, thus extending the life of a vehicle's electrical system and reducing battery and alternator failure, with minimal inconvenience to a user. Devices, methods, and systems that can adjust automatically or with minimal user intervention are especially desirable.

### SUMMARY

In certain embodiments, the present technology is directed to a mobile charging device configured to connect to a power source located within a vehicle having a vehicle battery and a vehicle engine, the mobile charging device comprising:
(a) a connector that connects the mobile charging device to the power source within the vehicle;
(b) a voltage sensor configured to detect a voltage of the vehicle battery; and
(c) an inertial measurement unit (IMU) configured to detect movement of the vehicle engine;
wherein the mobile charging device is configured to switch between a “default” mode and a “sleep mode” when detecting a change in movement of the vehicle.

In certain embodiments, the present technology is directed to a method of reducing the energy consumption of a mobile charging device located within a vehicle and connected through a connector to a vehicle battery and a vehicle engine, the method including the steps of:
(a) detecting, through the connector, movement of the vehicle engine or a change in voltage from the vehicle battery; and
(b) switching between a “default” mode characterized by a voltage of 13V to 14.7V, and a “sleep mode” characterized by a voltage of lower than 13V, when a voltage event of more than 4V is detected.

In certain embodiments, the present technology is directed to a portable electronic system configured to provide power to a portable electronic device while preserving the life of a vehicle's engine, alternator, or electrical system, the portable electronic system comprising:
(a) a mobile charging device configured to connect to a power source located within a vehicle having a vehicle battery and a vehicle engine, the mobile charging device comprising:
   (i) a connector that connects the mobile charging device to the vehicle;
   (ii) a voltage sensor configured to detect a voltage of the vehicle battery through the connector; and
   (iii) an inertial measurement unit (IMU) configured to detect movement of the vehicle's engine; wherein the mobile charging device is configured to switch between a “default” mode and a “sleep mode” when detecting a change in movement of the vehicle engine; and
(b) a dashboard camera, a mobile (cellular) phone, a smartphone, a camera, or a computer connected to the mobile charging device.

### BRIEF DESCRIPTION OF THE DRAWINGS

FIG. 1 shows a flowchart demonstrating the components of an exemplary embodiment of a device, method, or system described herein.

FIG. 2 shows a device, in accordance with certain embodiments herein.

FIG. 3 shows certain interior components of a device, in accordance with certain embodiments herein.

FIG. 4 shows an exemplary setup of a device connected with a dashboard camera, in accordance with certain embodiments herein.

### DETAILED DESCRIPTION

As used herein, “substantially” means within 5% of a value. For example, “substantially drained battery” means having no more than 5% battery power; and “substantially fully charged battery” means having no less than 95% full battery power.

As used herein, “removable” means capable of being separated through ordinary and intentional manual force, such as with a user's hand, and without any tools.

As used herein, a “mobile device” or “portable electronic device” are terms used interchangeably and both mean an electronic device that is powered by a battery, whether internal (for example, through an integrated internal storage unit for electrical power) or not (for example, through a cable); and that can be carried around on a person, without the need for being fixed to a particular location and without the need for a permanent power source at all times during operation—that is, that can be used without being attached to a permanent power source, and then can recharged by attaching to a source of electricity (a power source) with a charging cord. A mobile device can be, for example, a mobile (cellular) phone, a camera (such as a dashboard camera) or any portable electronic device that can connect to the internet, including a smartphone or a tablet computer. It should be noted that many dashboard cameras (“dashcams”) have energy storage capabilities in the form of an internal battery or capacitor; however, their primary source of operational power while in use is typically from the vehicle's battery or electrical system. In such a situation, a dashboard camera would be considered a “mobile device” within the present definition.

As used herein, “mobile charging device” means a device that can charge a mobile device in any location by connection to a source of electricity, such as an electrical outlet. Typically, a mobile charging device can be attached to a mobile device, can charge the device, and then can be detached while the mobile device is being used and while the mobile device's internal rechargeable battery is drained.

As used herein, a “dashboard camera” (also referred to herein interchangeably as a “dashcam” or “dash camera”) means a portable electronic device that is powered by a battery, whether internal (for example, through an integrated internal storage unit for electrical power) or not (for example, through a capacitor); and that can be mounted or otherwise connected within the interior of a vehicle, and that can capture or record video or audio footage. It should be noted that many dashboard cameras can have energy storage capabilities in the form of an internal battery or capacitor; however, their primary source of operational power while in use is typically from the vehicle's battery or electrical system.

A dashboard camera typically has an audio or video input—that is, it is configured to capture footage from the ambient surroundings (e.g., the interior of the vehicle or any other area surrounding the dashboard camera) and then store the footage. It also typically has a cord or cable that connects it to a power source.

As used herein, “voltage event” or “voltage transient” means a significant change in the voltage of a vehicle's battery that is indicative of a change in the operating state of the vehicle—for example, the characteristic voltage sag that occurs during engine cranking (when the starter motor draws high current, momentarily reducing battery voltage), or the voltage shift that occurs when an alternator begins or ceases charging. In the case of an electric vehicle, a “voltage event” or “voltage transient” can include any measurable change in battery voltage associated with the vehicle powering up or powering down.

A “voltage event” is distinct from physical movement or vibration of the vehicle, which in certain embodiments herein is detected separately by an inertial measurement unit (IMU). As used herein, “change in movement” or “change in motion” refers to a physical change in the vibration, acceleration, or orientation of the vehicle or any component thereof (including the vehicle engine), as detected by one or more of an accelerometer, gyroscope, or magnetometer. In certain embodiments, a device herein uses both voltage events and changes in movement, independently or in combination, to infer the operating state of the vehicle—for example, to determine whether the vehicle is running, starting, or parked.

In certain embodiments, a device, method, or system herein can detect any physical movement that is caused by movement of the vehicle engine, including movement of the vehicle engine itself.

As used herein, “engine” means a machine that converts energy into mechanical force and motion; and includes any such machine that powers any vehicle, whether a gasoline-powered vehicle (an internal combustion engine) or an electric vehicle (EV). For example, as used herein, “engine” includes an EV's inverter, motor, or regenerative braking equipment.

As used herein, “connector” means any device that is adapted to connect a device herein to any power source, and can include, for example, a hub, a charger, or a combination of any of these with a power cord (any part of such combination being defined as a “connector”).

### Existing Products on the Market

Supplying power to a dashboard camera is commonly done in one of two ways:
1. Fusebox “Hardwire Kits”: DC-DC USB converter is wired to the fusebox of the vehicle, typically located in the driver or passenger footwell of the vehicle's interior.
2. “Dashcam Adapters”: DC-DC USB converter is wired in parallel to an autodimming mirror, rain sensor, or similar DC device in the vehicle, using a breakout harness.

Known products currently on the market include “3 Wire” Fusebox hardwire kits which include a power cord connected to a transformer box, with a set of 3 wires—the first being a wire that supplies constant battery power; the second being a wire that provides an ignition “on” and “off” signal and plugs into the ACC fuse socket (also known as an “ACC” wire”); and the third being a ground wire.

In terms of function, currently known products typically allow constant (24 hours) operation, regardless of the ignition state of the vehicle. In general, known fusebox “Hardwire Kits” are considered to be more feature-rich because they are more-readily able to access both “constant-power” (continuously supplied power from a vehicle's battery) and “ignition-switched power” (also known as the “ACC” power, or power that is only supplied when the vehicle is put in an “ON” state by the driver). Table 1 shows some “pros” and “cons” of the two known types of dashboard camera configurations:

TABLE 1

| Fusebox Hardwire Kits | Dashcam Adapters |
|---|---|
| PRO: advanced features such as 24- | CON: advanced features are possible only if |
| hour low-voltage monitoring due to | both ignition-switched power and constant |
| both constant-power and ignition- | power are available. |
| switched power being available | PRO: Very Compact due to less input needed. |
| CON: Very bulky due to extra length | Fewer wires needed to route to fusebox |
| of wires, or presence of switches or | |
| screens | |

There are dashcam adapters on the market (for example, Dongar® PRO products) that have implemented these advanced features found in Fusebox Hardwire kits in the form factor of a dashcam adapter. However, these still require that both constant-power and ignition-switched power be available at the location of installation.

### Two Wire Configurations

The devices, methods, and systems herein are advantageous in that, in certain embodiments, they can deliver the full feature set of traditional 3-wire fusebox hardwire kits (parking mode recording, low-voltage battery protection, timed shutdown) in a more efficient and more compact 2 wire configuration. These advantages can be achieved by, in certain embodiments, replacing the dedicated ignition-sense (ACC) wire with an onboard inertial measurement unit (IMU) containing one or more of an accelerometer, gyroscope, and magnetometer sensor, paired with a controller (e.g., a microcontroller) running an algorithm that can infer vehicle ignition state from a combination of voltage signature analysis (e.g., cranking sag, alternator charge or discharge transients) and in certain embodiments, motion or vibration detection. The result can be a device that requires only a constant-power and ground connection, yet can autonomously determine when the vehicle is running, parked, or starting; and in certain embodiments can manage dashcam power accordingly—eliminating the need for complex fusebox wiring while retaining advanced parking mode functionality.

In various embodiments, a device, method, or system herein comprises no more than, or only or exactly, two wires for input—for example, a first wire configured to supply battery power of the vehicle (e.g. constant or substantially constant battery power), and a second being the grounding wire (i.e., configured to ground the mobile charging device). In certain embodiments, the second wire connects the interior of the device to the vehicle chassis ground. In such embodiments, a third wire is not necessary because a combination of sensors and an algorithm (as described in detail herein) is instead used to infer whether the ignition is on (or whether the engine is running or the car is in motion).

By way of further explanation, in such embodiments, a “two wire” configuration refers to an input of the device. That is, in certain embodiments, an output (for example, the USB output) is not a “wire” as the device can be fully functional regardless of whether the USB cable is plugged in.

### USB Connector

In certain embodiments, a device herein has a mobile charging device wherein the connector comprises a USB plug. Such plug can be, in various embodiments, enclosed in an enclosure. In certain embodiments, such enclosure is a slim “gum stick sized” enclosure, and optionally with a breakout harness having a shorter length than those currently used—including, in various embodiments, a length of under 10 inches, or under 9 inches, or 2 to 8 inches, or 3 to 8 inches. As used herein, “gum stick sized enclosure” means a thin, rectangular case that is roughly the same size and shape as a standard stick of chewing gum—that is, 20 to 24 mm wide, and 30 to 90 mm, or 40 to 80 mm in length.

The small size of such enclosure can be advantageous in many ways. In particular, this is in contrast to known devices, which typically have a USB converter in a known rectangular enclosure with a fixed wire of 10 to 20 feet, with fuse holder “taps” to access constant power and ignition signals.

In certain embodiments, a mobile charging device herein is adapted to be plugged into an electrical outlet located in the interior of a vehicle—for example, an automobile auxiliary power outlet, such as those traditionally designed as “cigarette lighter” ports, and having a voltage of 12 VDC (which may be elevated to the range of 13.5 VDC to 15 VDC when the vehicle is running); and defined in the United States by UL Standard 2089 regarding vehicle battery adapters; or a universal serial bus (USB) outlet (including a USB-A, USB-B, USB-C or micro-USB outlet).

In certain embodiments, when referring to a “connector” herein, the present disclosure refers to a connector comprising a port such as a USB port; or alternatively, a connector that comprises a plug, including but not limited to an OEM (original equipment manufacturer) plug, that serves a different function (for example, powering garage door buttons or detecting lighting conditions). In certain embodiments, a connector herein comprises an OEM plug or a USB plug that contacts an electrical outlet located in the interior of the vehicle.

In certain embodiments, the present technology is directed to a mobile charging device that can connect to a vehicle, wherein the mobile charging device has a cranking detection feature. As used herein, “cranking detection feature” refers to any feature of a mobile charging device herein that is configured to detect a change in the operating state of the vehicle for example, by detecting a voltage event, a change in movement, or both thereby enabling the device to infer the presence or absence of ignition-switched power (also referred to herein as “ignition power” or “ignition-on power” or “switched power” or “ACC power” or “accessory power”) without requiring a dedicated ignition-sense wire.

For example, a mobile charging device herein can be a car charger (e.g., having a USB-A or USB-C connector) that has a cranking detection feature; this can be ideal for use in vehicles where ignition power is not available, and can provide fast charging for devices such as USB-A or USB-C compatible devices. In certain embodiments, the power detected refers to the power of a gasoline-powered vehicle, an electric vehicle (EV), or a hybrid vehicle.

For example, in certain embodiments, to conserve the car battery, a mobile charging device herein can feature a sleep mode that activates when the vehicle is turned off or is inactive for an extended period. In this “low power mode” or “sleep mode” state, the mobile charging device can operate with a significantly or substantially reduced energy consumption, preventing unnecessary battery drain and thus prolonging the life of the vehicle. In certain embodiments, a mobile charging device herein has a feature wherein it automatically “wakes up”—that is, resumes its normal functions when the car is restarted.

Thus, in certain embodiments, a mobile charging device (or related system or method herein) can switch between a “default mode” characterized by a voltage of greater than 13V, and a “sleep mode” characterized by a voltage of lower than 13V, when a change of vehicle system voltage changes more than 4V, or more than 5V, or more than 6V—or put another way, when a “voltage event” or “voltage transient” of more than 4V, more than 5V, or more than 6V is detected.

As a practical matter, industry standards generally deem that below 11.8V value, it is generally too low for the vehicle to start. In certain embodiments, the physical phenomenon detected is acceleration, which has units of m/s² (meters per second squared) or g (which is 32.2 feet per second squared), but the output of many accelerometers is just an electrical signal with an arbitrary baseline. That is, the accelerometer generally produces a signal when it is in motion, and no signal when not moving. In certain embodiments, a sensor herein produces a unitless number 0 to 256, and a device herein does not necessarily detect a numerical value, but rather, the presence of a signal, which can trigger the switch between “default mode” and “sleep” mode (the “wake up” step or the “go to sleep” step).

As used herein, “sleep mode” or “low power mode” means operating with reduced energy consumption; in particular, in certain embodiments herein, in the range of lower than 13V, lower than 12.6 V, or 12V to 12.9V, or 11.9V to 12.9V, or 11.9V to 12.6V.

As used herein, “default mode” means operating with a normal and ordinary (not reduced energy consumption); in particular, in certain embodiments herein, in the range of higher than 13V, higher than 12.9V, or 13V to 14.7V, or 13V to 14.5V, or 13.5V to 14.5V.

As used herein, “wake up” means switching from sleep mode to default mode, and “go to sleep” means switching from default mode to sleep mode. This can be instigated by, in various embodiments, the cranking of the vehicle engine (or the cessation of cranking of the vehicle engine), or by manual switching.

In certain embodiments, a mobile charging device herein comprises one or more of the following functions: a car cranking function (corresponding to engine ignition, engine starting, engine cranking, or engine running), or a parking detection function (corresponding to the detection of the engine's being turned off).

In certain embodiments, a mobile charging device herein can include one or more elements that can accomplish one or more of the following characteristics, for example, as part of the car cranking function or the parking detection function:
1. Voltage Sensing—In certain embodiments, a device herein comprises a component that is configured to measure the vehicle's battery voltage. A significant drop in voltage typically occurs during engine cranking, due at least in part to the relatively high-power demand of the starter motor. This can be a key indication of engine startup. When a car engine is running, the alternator charges the battery, and the voltage typically remains above 13.5 to 14.5 V. In certain embodiments, it is also possible to detect whether and when the engine is running, because the battery voltage is transient (or noisy) as the alternator power fluctuates as the vehicle is being driven. When the engine is turned off, the reading is stable and predictably declines. Once the engine is turned off (that is, when the car is parked), the alternator stops, and the battery voltage gradually drops to its resting state (typically around 12V to 12.6V).
2. Accelerometer—In certain embodiments, a mobile charging device herein comprises an accelerometer component, which can detect physical movement or vibrations associated with engine ignition and cranking—that is, voltage events or voltage transients. The rapid rotational motion of the engine during the startup process can produce a distinct vibration signature, which the accelerometer can capture. In certain embodiments, the accelerometer can detect movements throughout the enclosure of the device—for example, the device is attached to the windshield and the oscillation of the engine running can be sensed from there. Alternatively, any movement within the vehicle could also be detected by the accelerometer, even if a device herein is not fully in contact with, or only partially in contact with, any surface of the interior of the vehicle (for example, if it is suspended from the ceiling and hanging in mid-air).
3. Gyroscope—In certain embodiments, a mobile charging device herein comprises a gyroscope, which is a sensor that measures angular velocity and rotation. During cranking (engine startup), the rotational movement of any of the engine components can cause detectable changes in the vehicle's orientation or angular motion, which can be sensed by the gyroscope. In certain embodiments, the gyroscope transmits this information to the mobile charging device herein.

In certain embodiments, by providing one or more of the above features (or combining two or more of the above features)—that is, voltage dips, physical vibrations, and rotational motion—a mobile charging device herein has a portion (for example, a circuit) that can detect when the car engine is cranking and when it is stopped (i.e. when the car is parked). This can ensure accurate detection even in varying conditions.

In certain embodiments, a mobile charging device herein comprises a controller—e.g., a microcontroller, that can, among other functions, apply one or more signal processing algorithms or thresholds to filter out noise and false positives.

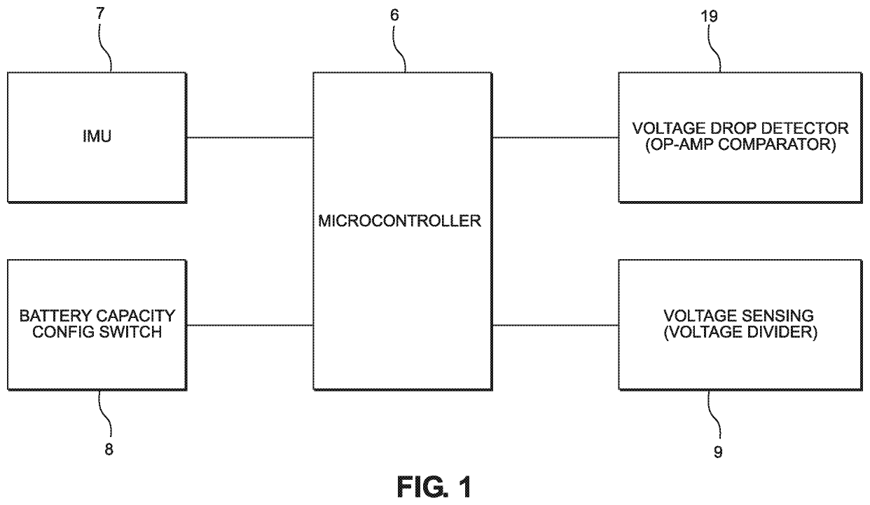

FIG. 1 shows an exemplary device, method, or system according to certain embodiments herein. As shown in flowchart depicted in FIG. 1, in certain embodiments the electrical design of a mobile charging device herein comprises one or more of the following components:
1. Controller—A main programmable component that can, in certain embodiments, include a controller; this can be, but is not limited to, a microcontroller; this can comprise, for example, custom code for one or more of: controlling the charging process, monitoring battery voltage, detecting engine cranking and parking, ensuring safety features, implementing fuel gauge and the like.
2. IMU—In certain embodiments, an inertial measurement unit (IM) is present. “IMU” means an electronic sensor device that measures an object's specific force, angular rate, and sometimes magnetic field, using combinations of accelerometers, gyroscopes, and magnetometers. Commercially available IMUs include BMI270 which is a low power, smart IMU available from Bosch Sensortec™ and designed for wearable and portable devices. It can combine a 3-axis accelerometer and a 3-axis gyroscope into a single sensor, providing motion tracking and orientation detection. In certain embodiments, the component can wake up the microcontroller when the event is detected. Thus, in various embodiments described herein, an IMU can comprise any configuration of the above-described components, e.g., one or more of an accelerometer, a gyroscope, or a magnetometer.
3. Voltage Drop Detector—In certain embodiments, a component herein comprises a voltage drop detector such as an op-amp comparator, which monitors the vehicle's battery voltage and can detect the characteristic voltage drop during engine cranking. This can be, for example, a voltage drop of at least 4V, at least 8V, at least 10V, 2 to 10V, or 2 to 6 V. In certain embodiments, a voltage drop detector herein can compare the real-time battery voltage to a predefined reference voltage (for example, from value in the range of 13V to 14.7V, down to a value in the range of 12 to 12.9V) that corresponds to the expected voltage drop during cranking. The circuit can then “wake up” the microcontroller when an event is detected. The voltage drop can vary by type of vehicle, as well as make and model of the vehicle. For example, in certain embodiments, the voltage can drop from 3 to 6 V (for example, from 14V down to 10V), momentarily. In certain embodiments, the voltage does not drop below a value of 10V, or below a value of 9V, as this can indicate a problem with the vehicle's battery. As a note, a single AA battery has a voltage of 1.5V, and 8 AA batteries provide a combined voltage of 12 V.

Thus, in certain embodiments, the reduction of the energy consumption between the “default” mode and the “sleep” mode (the voltage drop) is at least 10V, at least 8V, at least 6V, at least 4V, or 2 to 12V, or 4 to 10V.
4. Voltage Sensing—In certain embodiments, a circuit herein can interface with an ADC (analog-to-digital converter), allowing a controller (e.g., a microcontroller) herein to monitor the vehicle battery's status. The circuit can help the controller to “understand” when to turn off the USB output and enter “sleep mode.” For example, in certain embodiments, a design herein can include one or more integrated sensors.

### Housing, Inlet and Outlet

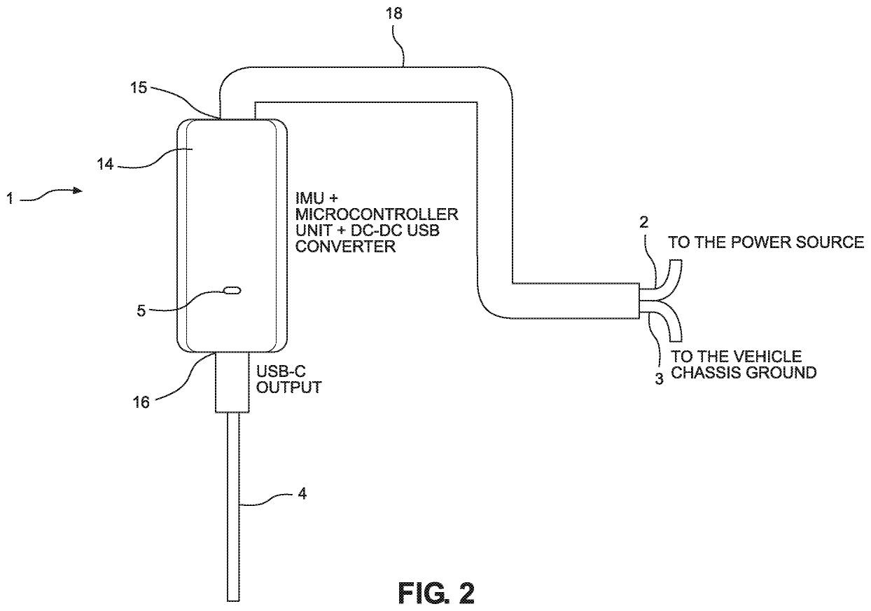

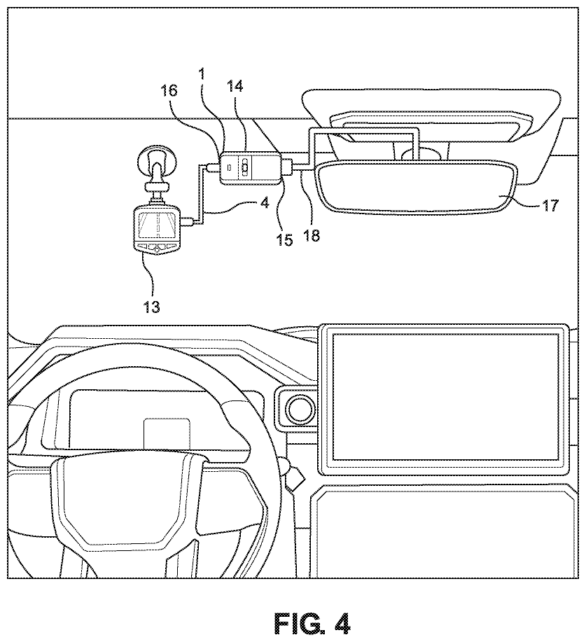

In certain embodiments, a device herein is configured such that any portion of any of the above-mentioned components (e.g., a connector, a voltage sensor, or an IMU) are partially or entirely enclosed within a housing. In various embodiments, a housing can comprise an inlet through which the connector connects the mobile charging device to the vehicle, and an outlet through which the mobile charging device connects to a portable electronic device. This can be seen, for example, in FIG. 2 and FIG. 4. In certain embodiments, the connector is at least partially outside of the housing—for example, it can comprise a hub that plugs into the power source of the vehicle—e.g., through a port that connects to the battery.

As shown in the exemplary embodiment of FIG. 1, in certain embodiments a controller, such as a microcontroller 6, can be configured to control any of: an IMU 7, a battery capacity configuration switch 8, a voltage drop detector 19 (for example, an op-amp comparator), or a voltage sensing unit 9 (for example, a voltage divider).

FIG. 2 shows an embodiment of a device, method, or system herein. As can be seen in the embodiment shown there, an adapter device 1 can include an IMU+microcontroller unit+DC-DC USB convertor enclosed within a housing 14. In the embodiment shown in FIG. 2, the first wire 2 and second wire 3 are housed together (“jacketed”) in an input cord 18 (also referred to herein as a “two-wire input” or “single-cable, 2-conductor input” or “2-wire jacketed input cable”); As shown, the first wire 2 is configured to connect to the power source (in certain embodiments, to supply constant battery power, for example, from the vehicle itself). The second wire 3 connects the interior of the device to the vehicle chassis ground).

Thus, a third wire is not necessary in such embodiments, because a combination of sensors and an algorithm can instead be used to infer whether the ignition is on (or whether the engine is running or the car is in motion). The embodiment shown in FIG. 2 also includes an output cord 4 (including, but limited to, a USB output cord. This output cord 4 can, as further shown in FIG. 4, be connected to an electronic device in the car, including but not limited to a dashboard camera or a computer), and an indicator light 5. As shown in the embodiment in FIG. 2, the housing 14 can comprise an inlet 15 through which the mobile charging device is connected to the vehicle, and an outlet 16 through which the mobile charging device connects to a portable electronic device.

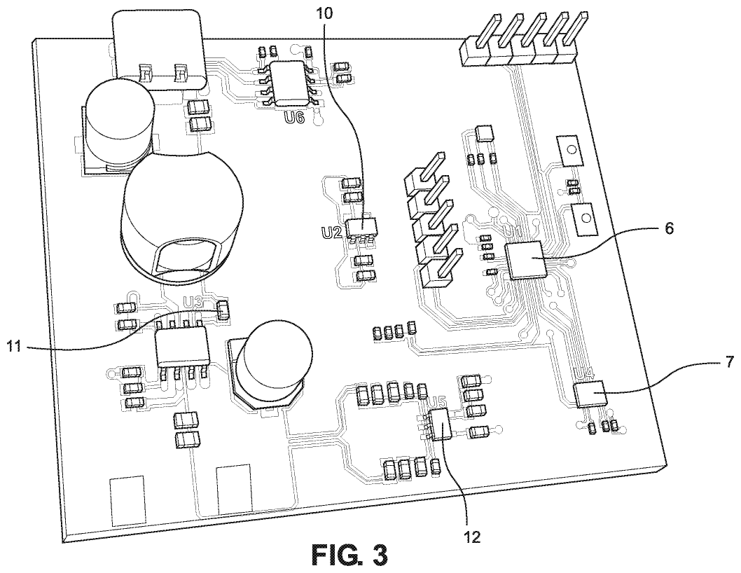

More details of an exemplary setup are shown in FIG. 4. A dashboard of a vehicle is shown, wherein a device 1 as described in certain embodiments herein comprises a housing 14 enclosing at least part of any of the components describe herein. As shown in FIG. 4, in the embodiment shown, an input cord 18, which holds the first wire 2 and the second wire 3 (not visible in FIG. 3), connects the interior of the device to the power source—that is, the vehicle's electrical system—in this case, through a port near the base of the rearview mirror 17, that plugs into the vehicle's power system, without the need for using the cigarette lighter port in the vehicle. Further, as shown in the embodiment in FIG. 4, an output cord 4 connects the device through an outlet 16 to a dashboard camera 13. In such a manner, a user can enjoy the full use of a device herein and a dashboard camera, without the need to plug either of them into the traditional cigarette lighter port, thus freeing up that port for other use by the passengers in the vehicle.

The embodiment in FIG. 4 shows a device 1 according to certain embodiments herein that is configured to attach to the interior of the vehicle—in that case, the windshield. This can be done with any known adhesive, or through suction, with a mechanical holder, or any known configuration through which known dashboard devices are typically mounted inside vehicles. However, in other embodiments, a device herein can be left free-hanging, for example, by its wires, without breaking the connection between either the device or the vehicle's power source.

In certain embodiments, a draft PCBA view is configured as shown in FIG. 3. The embodiment shown there shows a microcontroller 6, a regulator 10, a “step-down” converter 11. (also known as a “buck converter,” which can receive the vehicle's input voltage typically in the range of 9V to 16V depending on engine state and can convert it to a lower, regulated output voltage suitable for powering the USB output and downstream components; in certain embodiments, this DC-DC conversion stage can permit a device herein to operate efficiently across the wide range of voltages encountered in a vehicle's electrical system). In certain embodiments, as shown for example, in FIG. 3, an IMU 7 (including, e.g., an accelerometer & gyroscope sensor), and a USB Protocol Charger IC 12 (which negotiates the appropriate charging protocol with a connected device; for example, modern portable electronic devices may support one or more fast-charging protocols such as USB Power Delivery, Quick Charge, or similar standards, and the USB Protocol Charger IC communicates with the connected device to determine the maximum safe rate of power delivery, enabling the mobile charging device to deliver power at rates up to, in certain embodiments, 18 W or more).

To summarize, in the embodiment shown in FIG. 3,
U1: Microcontroller
U2: Regulator
U3: “Step-Down Converter”
U4: “IMU” (accelerometer & gyroscope sensors)
U5: “USB Protocol Charger IC”

In existing “two-wire” dashcam power adapter on the markets, one would typically find components U2+U3+U5. In existing “three-wire” dashcam power adapter on the market, one would typically find components U2+U3+U5+U1. In various embodiments, a device herein is unique in that, among other reasons, it can provide a “two-wire” dashcam power adapter on the market+the IMU (U4).

Put another way, in existing “two wire” dashcam power adapters on the market, one would typically find components regulator+“step-down” converter+USB protocol charger IC. However, existing two wire dashcam power adapters lack many features; among them, an IMU, a microcontroller, and the associated algorithm—and as a result, they have no means of inferring whether the vehicle's engine is running or whether the vehicle is parked. Without an ignition-sense signal (which, in three wire configurations, is provided by a dedicated ACC wire), existing two wire adapters function only as continuous power delivery devices, supplying power to the connected dashcam regardless of the vehicle's ignition state. This means existing two wire adapters cannot, among other features:
autonomously switch a connected dashcam between a driving mode and a parking mode; cannot implement low-voltage battery cutoff protection based on an understanding of vehicle state; or
provide timed shutdown or energy budgeting features (for example, recording for a predetermined period after the vehicle is parked and then entering sleep mode), because they have no means of detecting when a parking event has occurred.

In certain embodiments herein, the addition of one or more of an IM and a microcontroller running a signal processing algorithm to a two wire configuration can replace the function of the dedicated ACC wire found in three wire configurations the IMU can provide, inter alia, sensor data (including vibration signatures and motion detection), the microcontroller can process that data in combination with voltage signature analysis (for example, detecting cranking sag or alternator charge and discharge transients), and the algorithm can infer the vehicle's ignition state from these combined inputs.

The result is, in certain embodiments, a two wire device that can autonomously determine when the vehicle is running, starting, or parked, and can manage dashcam power accordingly—delivering the full feature set of a three wire fusebox hardwire kit without the need for a dedicated ignition-sense wire or complex fusebox wiring.

In existing “three wire” dashcam power adapter on the market, one would typically find components regulator+“step-down” converter+USB protocol charger IC+a microcontroller.

In certain embodiments, a device, method or system herein is superior over both three wire and two wire systems currently known. Among other reasons, it can provide a two wire configuration that also includes an IMU.

Table 2 shows a comparison of how features in certain embodiments herein can be implemented, in a way that is advantageous over known devices, methods, and systems.

TABLE 2

| | Existing 3-wire Fusebox | Exemplary “Kinematic |
|---|---|---|
| Feature | Hardwire Kits | Dashcam Adapter” |
| Detect vehicle | Directly reads voltage at ACC | Detects vehicle voltage sag in |
| ignition is | input (i.e., high of >12 V) | constant-power input |
| turned ON | | e.g, baseline reading of 12 V, |
| | | with a drop to 6 to 9 V for 1 to 2 |
| | | seconds indicating engine starter |
| | | is cranking |
| | | OR Detects motion/vibration of |
| | | vehicle, e.g . . . , motion flag |
| | | is turned ON after sensor |
| | | measurement |
| Detect vehicle | Directly reads voltage at ACC | Detects vehicle voltage |
| ignition is | input (i.e., ~0 V) | transients in constant-power |
| turned OFF | | input |
| | | e.g., baseline reading of >13 V |
| | | with short spike and then drops |
| | | to ~12 V indicating the engine or |
| | | power generator was shut off |
| Dashcam is | Low voltage detected at ACC | IMU reading and algorithm has |
| shut down | input triggers an immediate shut- | inferred that vehicle motion has |
| | down, or timed shutdown (30 min, | stopped and initiates a shutdown |
| | 4 hrs, etc.) | timer or immediate timer |

### Methods and Systems

In certain embodiments, the present technology further contemplates methods of reducing the energy or power consumption of a mobile charging device located within a vehicle and connected through a connector to the vehicle battery and vehicle engine; as well as systems comprising the devices herein in connection with dashboard cameras and other features within a vehicle.

For example, the present technology contemplates, in certain embodiments, portable electronic systems configured to provide power to a portable electronic device while preserving the life of a vehicle's engine, alternator, or electrical system; as well as to dashboard camera systems that comprise any devices herein connected to a dashboard camera, or any other portable electronic device as described herein.

In various embodiments, a system herein can comprise a device connected with any electronic device or system that may be plugged into a power source for charging inside a vehicle—including, but not limited to: a mobile (cellular) phone, smartphones, camera, or computer (e.g., a tablet computer or a laptop). Numerous advantages can be achieved through such methods and systems, including convenience, as well as energy and cost savings.

In certain embodiments, the reduction of the energy between the “default” mode and the “sleep” mode is at least 6V; or the reduction in power consumption is at least 2.5 Watts (2.5 W) or at least 3 Watts (3 W) or at least 3.5 Watts (3 W). For example, a typical dashcam could use 5 W to 10 W, or 6 W to 8 W of power, and therefore a change of power in any of these ranges (e.g., a change of power of 6 W) could be expected between sleep and default modes. Dashboard cameras can use anywhere from 2.5 W to 18 W depending on particular features.

### Example 1

In particular Honda models, the map light (also known as the “dome light”) can be adapted to be a suitable source for dashboard camera power. The power circuit in this vehicle is typically in “always on” mode, allowing the driver to turn on the light regardless of whether the vehicle itself is powered on. The power source is in a convenient location to power a dashcam; however, it is otherwise unsuitable, as the dashcam would drain the vehicle battery. With the present technology, a user is able to “share” power with this dome light, and a device herein can independently turn the dash camera on or off by algorithmically determining (based on embodiments herein) whether the car is in motion or the engine is running.

### Example 2

In particular Hyundai models, the external ambient light and rain sensor can be adapted to be a suitable source for dash camera power. This power circuit is typically in “always-on” mode, allowing the vehicle to determine the amount of ambient light in the environment regardless of whether the car is on (this is useful for turning on exterior lights at night). This power source is in a convenient location to power a dashcam; however, it is otherwise unsuitable, as the dashcam would drain the vehicle battery. With the present technology, a user is able to “share” power with this external ambient light and rain sensor, and can independently turn the dash camera on or off by algorithmically determining (based on embodiments herein) whether the car is in motion or the engine is running.

Many advantages can be conferred by the devices, methods, and systems herein. Among them are: the ability to accomplish what known devices accomplish (and in fact, can improve upon them), but using only 2 wires, rather than 3; compact and efficient design; lightweight configuration that is easy to transport and use; superior ability to reduce significantly the energy consumption of a mobile charging device located within a vehicle and connected through a connector to the vehicle battery and vehicle engine; as well as to preserve or lengthen the life of the vehicle's engine, alternator, or other mechanisms. This can of course lead to greater convenience for a vehicle owner, and significant economic advantages over time. A further advantage is that the devices, methods, and systems herein can easily be adapted for use in many different makes and models of vehicles.

Although the present technology has been described in relation to embodiments thereof, these embodiments and examples are merely exemplary and not intended to be limiting. Other variations and modifications and other uses will become apparent to those skilled in the art. The present technology should, therefore, not be limited by the specific disclosure herein, and can be embodied in other forms not explicitly described here, without departing from the spirit thereof.

We claim:

1. A mobile charging device configured to connect to a power source located within a vehicle having a vehicle battery and a vehicle engine, the mobile charging device comprising:
(a) a connector that connects the mobile charging device to the power source within the vehicle;
(b) a voltage sensor configured to detect a voltage of the vehicle battery; and
(c) an inertial measurement unit (IMU) configured to detect movement of the vehicle engine;
wherein the mobile charging device is configured to switch between a “default” mode and a “sleep mode” when detecting a change in movement of the vehicle.

2. The mobile charging device of claim 1, wherein one or more of (a) through (c) are partially or entirely enclosed within a housing, the housing comprising an inlet through which the connector connects the mobile charging device to the vehicle, and an outlet through which the mobile charging device connects to a portable electronic device.

3. The mobile charging device of claim 1, wherein the IMU comprises one or more of an accelerometer, a gyroscope, or a magnetometer.

4. The mobile charging device of claim 1, wherein the vehicle is a gasoline-powered vehicle or an electric vehicle.

5. The mobile charging device of claim 1, wherein the connector comprises an OEM plug or a USB plug that contacts an electrical outlet located in the interior of the vehicle.

6. The mobile charging device of claim 3, wherein the connector comprises a USB plug in a slim gum stick sized enclosure, with a breakout harness having a length of under 10 inches.

7. The mobile charging device of claim 1, wherein an input into the device comprises no more than two wires: a first wire configured to supply battery power of the vehicle; and a second wire configured to ground the mobile charging device.

8. The mobile charging device of claim 7, wherein the first wire is configured to supply constant or substantially constant battery power of the vehicle.

9. A method of reducing the energy or power consumption of a mobile charging device located within a vehicle and connected through a connector to a vehicle battery and a vehicle engine, the method including the steps of:
(a) detecting, through the connector, movement of the vehicle engine or a change in voltage from the vehicle battery; and
(b) switching between a “default” mode characterized by a voltage of 13 to 14.7V, and a “sleep mode” characterized by a voltage of less than 13V, when a voltage event of more than 4V is detected.

10. The method of claim 9, wherein the vehicle is a gasoline-powered vehicle or an electric vehicle.

11. The method of claim 9, wherein the reduction of the energy consumption between the “default” mode and the “sleep” mode is at least 6V.

12. The method of claim 9, wherein the reduction of the power consumption between the “default” mode and the “sleep” mode is at least 2.5 W.

13. A portable electronic system configured to provide power to a portable electronic device while preserving the life of a vehicle's engine, alternator, or electrical system, the portable electronic system comprising:
(a) a mobile charging device configured to connect to a power source located within a vehicle having a vehicle battery and a vehicle engine, the mobile charging device comprising:
(i) a connector that connects the mobile charging device to the vehicle;
(ii) a voltage sensor configured to detect a voltage of the vehicle battery through the connector; and
(iii) an inertial measurement unit (IMU) configured to detect movement of the vehicle's engine; wherein the mobile charging device is configured to switch between a “default” mode and a “sleep mode” when detecting a change in movement of the vehicle engine; and
(b) a dashboard camera, a mobile (cellular) phone, a smartphone, a camera, or computer connected to the mobile charging device.

14. The portable electronic system of claim 13, wherein the IMU comprises one or more of an accelerometer, a gyroscope, or a magnetometer.

15. The portable electronic system of claim 13, wherein the vehicle is a gasoline-powered vehicle or an electric vehicle.

16. A dashboard camera management system comprising the device of claim 1 connected to a dashboard camera.
